(19) United States
(12) Patent Application Publication
(10) Pub. No.: US 2026/0104077 A1
(43) Pub. Date: Apr. 16, 2026

(54) Shaped Disc Pad

(71) Applicants: Spencer Edwin Daw, Agoura Hills, CA (US); Molly Sharon Daw, Agoura Hills, CA (US); Duncan Howard Daw, Agoura Hills, CA (US); Dylan Mitchell Daw, Agoura Hills, CA (US)

(72) Inventors: Spencer Edwin Daw, Agoura Hills, CA (US); Molly Sharon Daw, Agoura Hills, CA (US); Duncan Howard Daw, Agoura Hills, CA (US); Dylan Mitchell Daw, Agoura Hills, CA (US)

(21) Appl. No.: 18/914,169

(22) Filed: Oct. 12, 2024

(51) Int. Cl. F16D 65/092

(52) U.S. Cl. CPC F16D 65/092

(57) ABSTRACT

A brake pad for a disc-brake as used in a vehicle. The brake pad includes shaped disc contact areas on the side of the pad where the said brake pad makes contact with the brake disc during braking. The shaped nature of the pad consists of elevated and/or depressed features relative to the flat sides of the pad, generally in the shapes of sloped ridges and/or valleys, which run in an arcing configuration when viewed from the said pad's side view perspective.

### BACKGROUND OF THE INVENTION

This invention relates to a brake pad for a vehicle disc-brake system which said pad will mesh with and be complementary to a disc-brake system that utilizes a shaped brake disc. The disc of a disc-brake system is a generally flat circular metallic plate that is connected at its centerpoint to a road wheel at its centerpoint such that they are both attached to a common axle or axis around which they jointly and synchronously spin. When the road wheel turns the attached disc must also turn and if the said disc is caused to slow or stop the connected road wheel must synchronously slow or stop. The manual forced slowing or stopping of the disc is the braking effect.

Manual forced slowing of the disc is accomplished through the use of brake pads (friction agents) using a clamping motion to simultaneously apply equal and opposing forced sliding friction pressure onto the flat sides of the spinning disc. This clamping motion requires two separate pad contact areas and two separate brake pads, that is, one pad contact area and one pad for each side of the clamped disc. The mechanism that holds and deploys the said clamping pistons and brake pads is referred to as a brake caliper and there is usually one brake caliper per disc.

The brake pads generally make sliding friction contact with the disc in the areas of the disc beginning at the outside edges (perimeter) of the flat sides of the disc and then extend inward and toward the disc's centerpoint for about 2 or 3 inches. On a conventional brake disc these pad contact areas are generally smooth, flat, surfaces where the complementary and equally smooth, flat, and approximately 2 or 3 inch high and 3 or 4 inch wide (long) brake pads make pressurized sliding friction contact with the spinning disc to accomplish the said braking effect.

Vehicle disc-brake systems are a mature technology with a rich history of research and development which has been done, and continues, to provide optimum performance for both the brake pad and the disc including configurations, force pressures, sizes, and compositions of components, for efficiency, usability, and durability. Regarding the brake pad itself there have been refinements and advances to improve pad performance generally regarding minimizing pad residue, improving adhesion and durability and to stabilize the brake pad, thereby quelling or minimizing pad squeal, judder and knocking, and to generally improve brake feel.

Disc-brake pads are produced in many sizes to fit different vehicle applications and their braking requirements. The specific measurements used herein are not meant as required or even suggested regarding sizes but as an aid to communicating a concept. This invention is not pertaining to manufacturing processes, the operation of disc brakes in general or to specific materials but is limited to the shaping of the brake pad itself.

### SUMMARY OF THE INVENTION

A primary objective of this invention is to provide a brake pad for a disc-braking system that utilizes a shaped brake disc such that having a brake pad that has a complementary shaped contact area that will mesh with the said shaped disc's shaped features will thereby increase that systems efficiency and efficacy in engaging, maintaining and sustaining braking.

A shaped brake disc will have an increased available pad contact surface area which is best engaged and optimized by the use of a complementary shaped brake pad. Generally, shaping is the providing of a raised and/or a depressed feature or features in, and instead of, the traditionally flat surface area of the said pad.

The shaped pad features are comprised of generally raised and/or lowered elements that will present in the configuration of a ridged (and/or depressed) arc or concentric arcs, relative to the rotational axis of the complementary shaped disc when viewed from the pad's contact side view perspective.

The defining characteristic of a shaped pad is its ability to to fully encounter and engage with a shaped disc upon the application of braking pressure and to fully disengage from the shaped disc upon the release of braking pressure. This meshing pressurized contact, as above, requires the shaped pad to have a valley where the disc has a peak and to have a peak where the disc has a valley. The shaped nature of the pad will vary to be complementary to and mesh with the particular shaping of the particular shaped disc.

Other advantages and constructions of this invention will become apparent from the following detailed descriptions of some preferred embodiments when considered with the accompanying drawings.

### BRIEF DESCRIPTION OF THE DRAWINGS

FIG. 1 is a diagrammatic frontal view of a generic automotive disc-braking system including the orientation and inclusion of an edge view perspective of its disc and pads.

FIG. 2 is a diagrammatic half section cutaway and partially revolved perspective showing of the outboard side of a shaped brake disc with its upper right quadrant removed thereby simultaneously showing both the disc's outboard side and an exposed cut half section view of its edge.

FIG. 3 is a diagrammatic side view of a shaped disc showing its shaped features in their necessarily concentric circular nature relative to its rotational axis and includes showing the positional relation and interaction of the shaped disc with a complementary shaped brake pad.

FIG. 4 is a magnified diagrammatic view of the top half of FIG. 1 but now including the as modified disc from FIG. 2 as the disc being shown from the same edge view perspective as the disc in FIG. 1. Removing the disc's upper right quadrant allows viewing the disc's shaped features from an edge view perspective which said shaped features would otherwise be hidden or obscured by the arced nature of the shaped peaks.

The disc is shown with the same triangle wave shaped features on its outboard side as in FIG. 2 but now shown with a complementary triangle wave type shaped brake pad. The inboard side is shown with a sine wave shaped pad contact area and complementary sine wave shaped brake pad.

FIG. 5 is a similar edge view as FIG. 4, that is, using a disc with a removed upper right quadrant and having alternative shaped features in the pad contact areas, that is, a repeating square wave type shaping on its outboard side and a single convex shaped feature on its inboard side. A complementary square wave type shaped brake pad is shown on the disc's outboard side and a complementary concave shaped brake pad is shown on its inboard side.

### DETAILED DESCRIPTION OF A FEW PREFERRED EMBODIMENTS

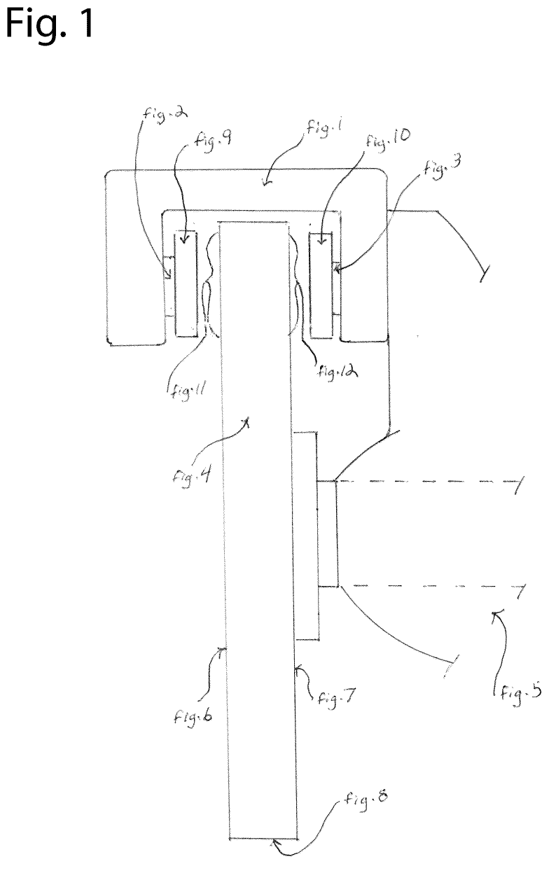

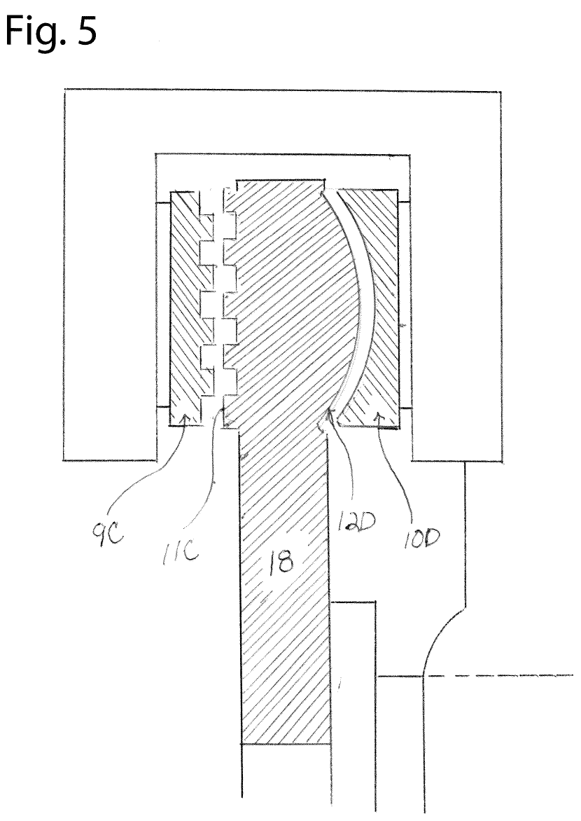

FIG. 1 depicts a generic automotive disc-braking system and is included for background, perspective and to illustrate the general operation of a disc-brake system including a caliper 1, being the mechanism which houses and deploys two separate and opposing sliding pistons, 2 and 3, which simultaneously forcefully extend when braking and thereby apply a clamping effect against the disc, 4, via the friction agents (brake pads) 9 and 10, attached to the tips of the said pistons, causing the slowing or stopping the disc's spinning. It includes showing the non-rotational fixed nature of the caliper, and therefore the brake pads, onto the hub/axle housing of the vehicle as FIG. 5. The disc is further described as having an outboard side 6 and an inboard side 7 and also an edge 8.

The disc (4) is further defined as having pad contact areas that are the specific areas of the disc that are or may be contacted by the pads during braking and are denominated as 11 (on outboard side 6) and 12 (on inboard side 7). FIG. 1 shows the rotor and brake pads in a non-pressurized/non-friction state and therefore a non-braking state.

The shown FIG. 1 is a dual piston caliper and one-piece disc but this invention pertains to any disc/piston configuration including floating one-piston calipers and/or split discs.

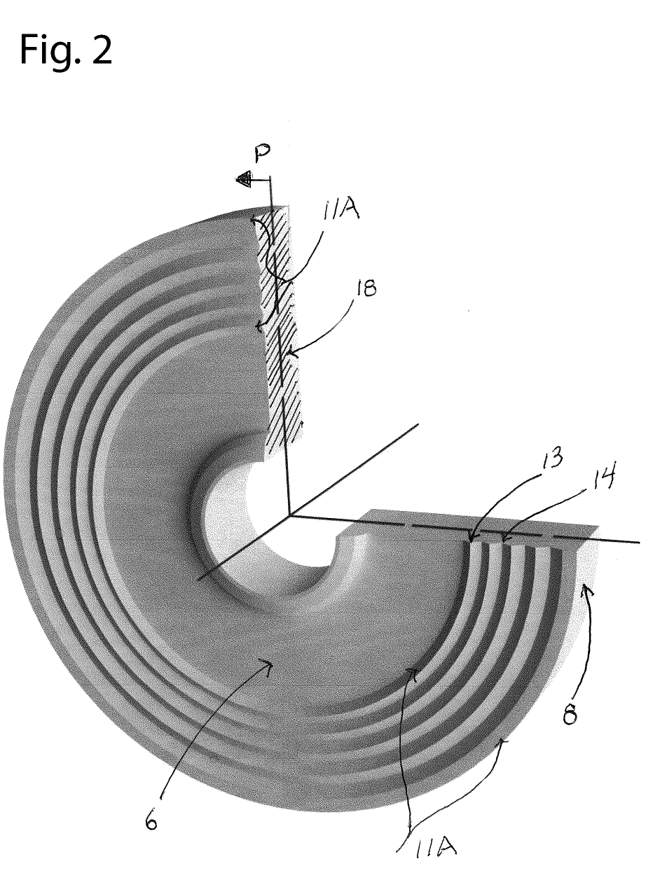

FIG. 2 shows a half section cut and partially revolved perspective of a shaped disc with triangular wave shaped features in the disc's outboard side's traditionally flat pad contact area 11. The formerly flat pad contact area 11 is now identified as pad contact area 11A identifying the pad contact area as being shaped with triangle shaped waves as further explained herein. The disc has been revolved about 25 degrees so that the outboard side 6 and the edge of the rotor 8 are concurrently visible. A “pie slice” segment comprising the disc's upper right quadrant has been removed as indicated by the cut line P, thereby exposing the disc's vertical inner surface 18 (identified via section lines) showing the hidden triangular wave shaped pattern of the pad contact area. The triangular wave shaped features are further identified as having peaks, identified as 13 and valleys as 14. The drawing shows the nature of the triangular wave features as being a series of concentric declining alternating peaks and valleys completely encircling the rotor within the annular ‘belt’ of its pad contact area. The said peaks and valleys form declining concentric circles and are not one declining ridge or valley. Further, the triangular wave type shaped pad contact area is occupying just the outermost, that is, toward the outer perimeter, 1 to 1½ inches of the traditionally flat pad contact boundary area instead of occupying the full traditional 2 to 3 inches of the disc as in a traditional flat pad contact area disc.

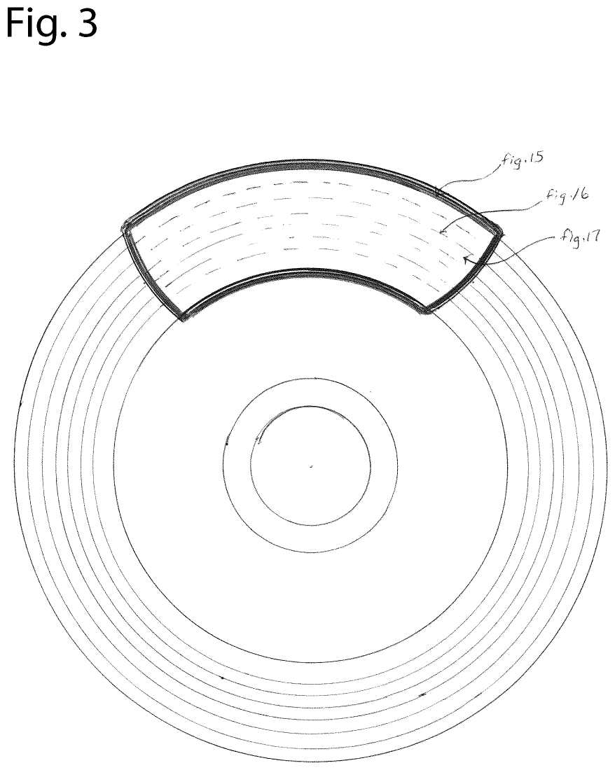

FIG. 3 is a side view of a triangular wave type shaped rotor showing the declining concentric circular nature of the disc's shaped features in the pad contact area with the lines representing triangular wave type peaks 13 and the blank spaces between the said peaks representing the valleys 14 between the said peaks. This illustration also shows a complementary triangle wave feature shaped brake pad 15 placed at the 12:00 o'clock position in the pad contact area of the disc which generally depicts the relationship of the said pad and rotor while in use. This brake pad 15 is shaped with the same and corresponding triangular wave features as the rotor but is complementary, that is, the features of the rotor and the pad mesh when one is placed atop the other as in this figure. The pad's broken concentric lines are its (the pad's) valleys 16 in its reverse and complementary triangular wave configuration. The pad's blank spaces 17, that is, the space between its valleys 16, are the pad's peak features.

The shaped features of the pad necessarily run in the form of an arc in order to mesh with the circular nature of the shaped disc's features of its pad contact area.

A complementary shaped pad is the much preferred adjunct to a shaped disc but if the disc's shaped features are minimal (little arc/slant and/or little height differential) a traditional flat pad might be able to erode to mesh with the shaped disc albeit sub optimally.

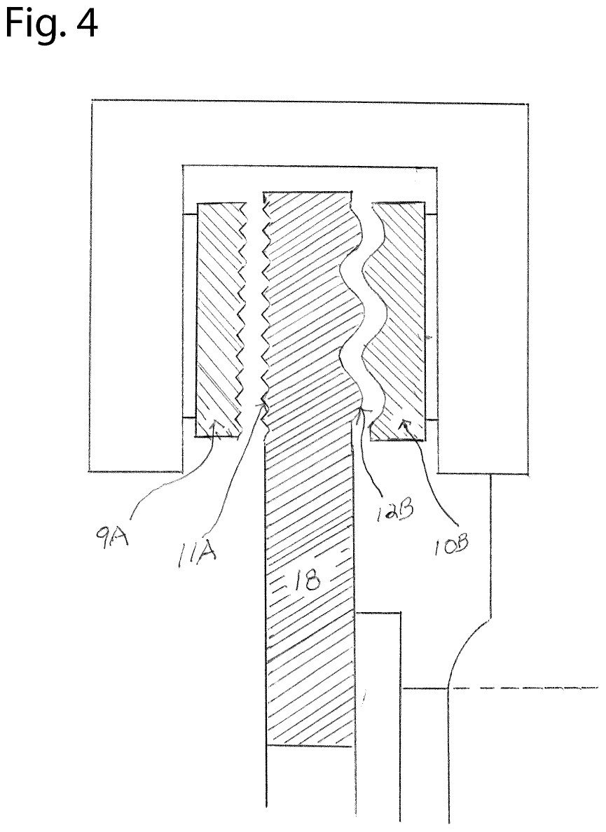

FIG. 4 is generally a view of a portion of the upper half of the braking system FIG. 1 with an emphasis on the pad contact areas 11 and 12 of the disc 4 and also showing the brake pads 9 and 10.

In this depiction the original generic disc 4 has been replaced by the modified disc as described in FIG. 2 such that the visible portion of the disc is a half section cut view of the exposed inner vertical Y axis surface 18 as identified by section lines, remaining after the removal of the disc's upper right quadrant. This edge view is a 90 degree revolved view relative to a flat side view.

The former flat pad contact areas 11 and 12 of the disc 4 in the traditional generic disc braking system FIG. 1 have been replaced on the outboard side by a triangular wave type shaped disc contact area now as 11A while the inboard side of the disc's pad contact area has been replaced with a sine wave type shaped pad contact area on its disc contact area now as 12B indicating a sine wave type pad contact area on its inboard side.

Complementary shaped brake pads are shown as 9A for the outboard triangle wave pad and 10B for the inboard sine wave pad. In each example the shaped brake pad has been fully sectioned, that is, cut in half, to expose the shaped features that would otherwise be obscured due to the arced nature of the shaped pad and the perspective from which it is being viewed. The area exposed by the removed portion is identified by section lines.

FIG. 5 is a variation of FIG. 4 including the use of the modified disc of FIG. 2 with its upper right quadrant removed in order to show an edge view of the shaped nature of the disc's pad contact area on the exposed vertical Y axis exposed surface 18. In this depiction the outboard side's pad contact area has been replaced by a square wave type shaped pad contact area, now 11C. The inboard side in this depiction has a single convex shaped feature in its pad contact area as 12D. This embodiment illustrates that a repeating feature is not required. Complementary shaped pads are shown as 9C for the square type outboard shaped pad and 10D for the inboard complementary concave feature shaped pad. As with FIG. 4, the shaped pads shown have been fully sectioned with their exposed surfaces identified by section lines.

The above illustrations are presented as some examples of preferred embodiments that exemplify the crux and spirit of the invention but they are not exclusive and those skilled in the art may present further variations and modifications so long as they don't deviate from the spirit or scope of the invention.

What is claimed is:

1. A brake pad for a vehicle disc-brake system, generally having two fixed non-rotating and opposing brake pads which, during braking, make pressurized sliding friction contact with the sides of a shaped spinning brake disc in a clamping motion to slow or stop the said disc, thereby slowing or stopping the connected vehicle, with said brake pads comprising, in the area of the pad that makes pressurized contact with the shaped disc during braking:
one or more raised and/or depressed features generally comprising a peak or peaks and/or a valley or valleys depending on what is required to mesh with the configuration of the particular shaped features of the said engaged shaped disc; and
which said pad shapings are comprised of features that mesh with the shaped features of the system's shaped disc when under pressurized braking and that disengage from the shaped disc when the said braking pressure is released; and
with said shaped pad being comprised as above by virtue of original construction, modification or otherwise including any and all construction methods, modifications, and/or materials.
